(19) United States
(12) Patent Application Publication
(10) Pub. No.: US 2025/0106624 A1
(43) Pub. Date: Mar. 27, 2025

(54) Home Network Parameter Update (HOPU) Procedure

(71) Applicant: Telefonaktiebolaget LM Ericsson (publ), Stockholm (SE)

(72) Inventors: David Castellanos Zamora, Madrid (ES); Cheng Wang, Shanghai (CN); Helena Vahidi Mazinani, Lund (SE)

(21) Appl. No.: 18/293,534

(22) PCT Filed: Jul. 4, 2022
(86) PCT No.: PCT/EP2022/068479

§ 371 Date: Jan. 30, 2024

(30) Foreign Application Priority Data
Jul. 30, 2021 (WO) PCT/CN2021/109607

(51) Int. Cl. H04W 12/04

(52) U.S. Cl. CPC H04W 12/04

(57) ABSTRACT

A wireless communication device (12) generates key material (22) during an authentication and key agreement procedure (18) with a home network (10) of the wireless communication device (12). The wireless communication device (12) transmits, as part of a home network parameter update procedure (14) to update the home network (10) with one or more parameters (12P), a message (20) that includes the one or more parameters (12P) and that protects the one or more parameters (12P) using the generated key material (22). In some embodiments, the home network parameter update procedure (14) is independent from, and/or is performable separately from, a user equipment, UE, parameter update, UPU, procedure for updating the wireless communication device (12) with a set of parameters (12P) stored at the home network (10).

### TECHNICAL FIELD

The present application relates generally to a wireless communication network, and relates more particularly to parameter update in such a network.

### BACKGROUND

A wireless communication device subscribes to receive wireless communication service from a wireless communication network referred to as the device's home network. The home network stores various parameters related to provision of wireless communication service to the wireless communication device. For example, in some types of wireless communication systems, the home network stores routing indicator data and/or default configured network slice selection assistance information (NSSAI). In this context, the home network may trigger a parameter update procedure to update the wireless communication device with those parameter(s), e.g., as those parameters dynamically change over time. See, e.g., the User Equipment (UE) Parameter Update (UPU) procedure specified in 3rd Generation Partnership Project (3GPP) Technical Specification (TS) 23.502 v17.1.0.

Conversely, the wireless communication device may need to update its home network with one or more parameters, e.g., stored at the device, such as capabilities of the device and/or privacy settings for location services. One known approach to updating the home network with the device's parameter(s) do so as part of the same procedure for updating the wireless communication device with the home network's parameter(s); namely, by including the updated parameter(s) in a response message that the device sends to the home network to acknowledge reception of the home network's update. Although this approach integrity protects the parameter(s) that the device sends to the home network, the approach proves inefficient because the home network must initiate the parameter update procedure in order to request the device to send its updated parameters. Other known approaches have the wireless communication device send its updated parameter(s) to the home network as part of the registration procedure. However, incorporating parameter update into the registration procedure has the disadvantage of increasing message overhead for all registration requests, even for registration requests that do not implicate parameter update.

Challenges therefore exist in updating a wireless communication device's home network with parameters at the wireless communication device, especially in a way that is efficient, with minimal signaling overhead impact, and secure.

### SUMMARY

Some embodiments herein introduce a home network parameter update procedure to update a wireless communication device's home network with one or more parameters. The home network parameter update procedure may be initiated and/or triggered by the wireless communication device itself, e.g., as opposed to having to be triggered by the home network. In these and other embodiments, the home network parameter update procedure may be independent from, and/or be performable separately from, a procedure for updating the wireless communication device with a set of parameters stored at the home network. In fact, in some embodiments, the home network parameter update procedure is performed after registration with the home network, e.g., so that key material generated during authentication and key agreement can be used for protecting the one or more parameters. Generally, then, the home network parameter update procedure may advantageously provide a way to update a wireless communication device's home network with parameters at the wireless communication device, in a way that is efficient, with minimal signaling overhead impact, and secure.

More particularly, embodiments herein include a method performed by a wireless communication device. The method comprises generating key material during an authentication and key agreement procedure with a home network of the wireless communication device, and transmitting, as part of a home network parameter update procedure to update the home network with one or more parameters, a message that includes the one or more parameters and that protects the one or more parameters using the generated key material.

In some embodiments, the home network parameter update procedure is initiated and/or triggered by the wireless communication device.

In some embodiments, the transmitted message is the first message in the home network parameter update procedure.

In some embodiments, the home network parameter update procedure is independent from, and/or is performable separately from, a user equipment, UE, parameter update, UPU, procedure for updating the wireless communication device with a set of parameters stored at the home network.

In some embodiments, the one or more parameters are confidentiality protected and/or integrity protected using the generated key material.

In some embodiments, the one or more parameters include one or more privacy settings for location services.

In some embodiments, the one or more parameters include one or more parameters that govern which location services clients are or are not allowed to access location information for the wireless communication device.

In some embodiments, the one or more parameters include one or more capabilities of the wireless communication device. In one or more of these embodiments, the one or more capabilities include one or more capabilities for steering of roaming, SoR, and/or one or more capabilities for UE parameter update, UPU.

In some embodiments, the one or more parameters include one or more parameters that indicate user consent for a service.

In some embodiments, the key material is generated during authentication and registration of the wireless communication device with the home network, and wherein the home network parameter update procedure is performed after registration of the wireless communication device with the home network.

In some embodiments, the one or more parameters are included in a home network parameter update data container carried within the message.

In some embodiments, the message is a non-access stratum, NAS, message.

In some embodiments, the message is transmitted to a network node implementing an access and mobility function, AMF.

In some embodiments, the message further includes integrity protection information that integrity protects the one or more parameters. In one or more of these embodiments, the method further comprises generating the integrity protection information from the one or more parameters and from the key material. In one or more of these embodiments, the integrity protection information comprises a message authentication code HoPU-MAC-I_{UE}. In one or more of these embodiments, the method further comprises generating freshness information associated with the key material, and wherein the integrity protection information is generated from the freshness information. In one or more of these embodiments, the freshness information comprises a counter. In one or more of these embodiments, the method further comprises monotonically incrementing the counter each time the wireless communication device calculates integrity protection information from the key material.

In some embodiments, the method further comprises triggering the home network parameter update procedure responsive to detecting, by the wireless communication device, a change in at least one of the one or more parameters at the wireless communication device.

In some embodiments, the method further comprises triggering the home network parameter update procedure responsive to detecting, by the wireless communication device, a change in an association between a permanent equipment identifier and a subscription permanent identifier associated with the wireless communication device.

In some embodiments, the key material used to protect the one or more parameters includes a key Kausf.

In some embodiments, the message further includes a request that the home network acknowledge receipt of the one or more parameters.

In some embodiments, the method further comprises responsive to transmission of the message, receiving, as part of the home network parameter update procedure, a message acknowledging receipt by the home network of the one or more parameters. In one or more of these embodiments, the received message also includes one or more parameters to be updated at the wireless communication device. In one or more of these embodiments, the one or more parameter included in the received message include routing indicator data and/or default configured network slice selection assistance information. In one or more of these embodiments, the one or more parameters included in the received message are protected using the generated key material. In one or more of these embodiments, the method further comprises decrypting, and/or verifying an integrity of, and/or verifying a freshness of, the one or more parameters in the received message using the generated key material. In one or more of these embodiments, the method further comprises updating the one or more parameters included in the received message at the wireless communication device responsive to successfully verifying the integrity of the one or more parameters included in the received message.

Other embodiments herein include a method performed by network equipment. The method comprises receiving, as part of a home network parameter update procedure to update a home network of the wireless communication device with one or more parameters, a message that includes the one or more parameters and that protects the one or more parameters using key material generated during an authentication and key agreement procedure between the wireless communication device and the home network.

In some embodiments, the home network parameter update procedure is initiated and/or triggered by the wireless communication device.

In some embodiments, the received message is the first message in the home network parameter update procedure.

In some embodiments, the home network parameter update procedure is independent from, and/or is performable separately from, a user equipment, UE, parameter update, UPU, procedure for updating the wireless communication device with a set of parameters stored at the home network.

In some embodiments, the one or more parameters are confidentiality protected and/or integrity protected using the generated key material.

In some embodiments, the one or more parameters include one or more privacy settings for location services.

In some embodiments, the one or more parameters include one or more parameters that govern which location services clients are or are not allowed to access location information for the wireless communication device.

In some embodiments, the one or more parameters include one or more capabilities of the wireless communication device. In one or more of these embodiments, the one or more capabilities include one or more capabilities for steering of roaming, SoR, and/or one or more capabilities for UE parameter update, UPU.

In some embodiments, the one or more parameters include one or more parameters that indicate user consent for a service.

In some embodiments, the key material is generated during authentication and registration of the wireless communication device with the home network, and wherein the home network parameter update procedure is performed after registration of the wireless communication device with the home network.

In some embodiments, the one or more parameters are included in a home network parameter update data container carried within the message.

In some embodiments, the message further includes integrity protection information that integrity protects the one or more parameters. In one or more of these embodiments, the integrity protection information is generated from the one or more parameters and from the key material. In one or more of these embodiments, the integrity protection information comprises a message authentication code HoPU-MAC-I_{UE}. In one or more of these embodiments, the message further includes a freshness information associated with the key material. In one or more of these embodiments, the method further comprises generating freshness information associated with the key material. In this case, the integrity protection information is generated from the freshness information. In one or more of these embodiments, the counter is monotonically incremented each time the wireless communication device calculates integrity protection information from the key material.

In some embodiments, the home network parameter update procedure is triggered responsive to detection, by the wireless communication device, of a change in at least one of the one or more parameters at the wireless communication device.

In some embodiments, the home network parameter update procedure is triggered responsive to detection, by the wireless communication device, of a change in an association between a permanent equipment identifier and a subscription permanent identifier associated with the wireless communication device.

In some embodiments, the message further includes a request that the home network acknowledge receipt of the one or more parameters.

In some embodiments, the message is a non-access stratum, NAS, message.

In some embodiments, the network equipment implements an access and mobility function, AMF.

In some embodiments, the method further comprises forwarding the message towards other network equipment. In one or more of these embodiments, the other network equipment implements a user data management, UDM, function.

In some embodiments, the network equipment implements a user data management, UDM, function.

In some embodiments, the method further comprises decrypting, and/or verifying an integrity of, the one or more parameters in the message. In one or more of these embodiments, the method further comprises updating the one or more parameters in the home network responsive to successfully verifying the integrity of the one or more parameters in the message. In one or more of these embodiments, the message includes integrity protection information that integrity protects the one or more parameters. In this case, verifying the integrity of the one or more parameters in the message comprises requesting an authentication server for expected integrity protection information, and comparing the integrity protection information included in the message with the expected integrity protection information received from the authentication server. In one or more of these embodiments, the message includes integrity protection information that integrity protects the one or more parameters, In this case, verifying the integrity of the one or more parameters in the message comprises transmitting the received message to an authentication server, and receiving, from the authentication server, an indication of whether or not the integrity of the one or more parameters in the message is successfully verified.

In some embodiments, the network equipment implements an authentication server. In one or more of these embodiments, the message is received from another network node that implements a UDM function. In one or more of these embodiments, the method further comprises decrypting, and/or verifying an integrity of, the one or more parameters in the message. In one or more of these embodiments, the message includes integrity protection information that integrity protects the one or more parameters. In this case, verifying the integrity of the one or more parameters in the message comprises calculating expected integrity protection information, and comparing the integrity protection information included in the message with the expected integrity protection information. In one or more of these embodiments, the method further comprises assisting other network equipment to decrypt, and/or verify an integrity of, the one or more parameters in the message. In one or more of these embodiments, the message includes integrity protection information that integrity protects the one or more parameters. In this case, assisting comprises calculating expected integrity protection information, and transmitting the expected integrity protection information to the other network equipment.

In some embodiments, the method further comprises responsive to receiving the message, transmitting, towards the wireless communication device as part of the home network parameter update procedure, a message acknowledging receipt by the home network of the one or more parameters. In one or more of these embodiments, the transmitted message also includes one or more parameters to be updated at the wireless communication device. In one or more of these embodiments, the one or more parameter included in the transmitted message include routing indicator data and/or default configured network slice selection assistance information. In one or more of these embodiments, the one or more parameters included in the transmitted message are protected using the generated key material.

Embodiments herein further include corresponding apparatus, computer programs, and carriers of those computer programs, e.g., non-transitory computer-readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a call flow diagram of a home network parameter update procedure according to some embodiments.

FIG. 3 is a logic flow diagram of a method performed by a wireless communication device according to some embodiments.

FIG. 4 is a logic flow diagram of a method performed by network equipment according to some embodiments.

FIG. 5A is a logic flow diagram of a method performed by network equipment according to other embodiments.

FIG. 5B is a logic flow diagram of a method performed by network equipment according to still other embodiments.

FIG. 6 is a logic flow diagram of a method performed by network equipment according to yet other embodiments.

FIG. 7 is a block diagram of a wireless communication device according to some embodiments.

FIG. 8 is a block diagram of network equipment according to some embodiments.

FIG. 9 is a block diagram of a wireless communication network according to some embodiments.

FIG. 10 is a block diagram of a user equipment according to some embodiments.

FIG. 11 is a block diagram of a network node in accordance with some embodiments.

FIG. 12 is a block diagram of a host according to some embodiments.

FIG. 13 is a block diagram of a virtualization environment according to some embodiments.

FIG. 14 is a block diagram of a host communicating via a network node with a UE over a partially wireless connection in accordance with some embodiments.

### DETAILED DESCRIPTION

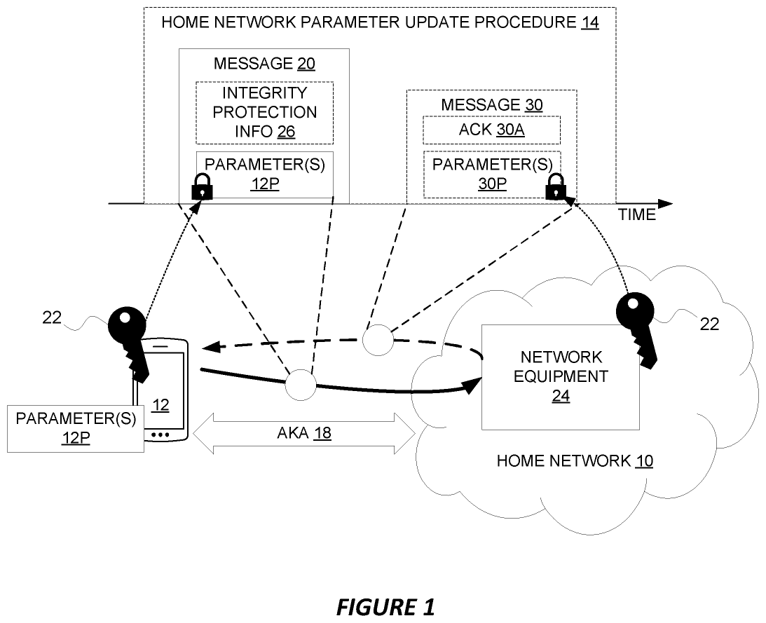

FIG. 1 shows a wireless communication device 12 according to some embodiments. The wireless communication device 12 receives wireless communication service from a wireless communication network, referred to as home network 10, on the basis of a subscription to that network 10. In some embodiments, the wireless communication device 12 accesses the home network 10 via an access network that is part of the home network 10. In other embodiments, though, such as when the wireless communication device 12 roams outside the wireless coverage provided by the home network 10, the wireless communication device 12 may access the home network 10 via an access network (not shown) provided by a visited network with which the home network 10 has a roaming agreement.

In this context, the wireless communication device 12 as shown is associated with one or more parameters 12P. At least some of the parameter(s) 12P may for example govern, indicate, or reflect one or more capabilities of the wireless communication device 12, e.g., one or more capabilities for steering of roaming (SoR) and/or one or more capabilities for User Equipment (UE) Parameter Update (UPU) as described herein. Alternatively or additionally, one or more of the parameter(s) 12P may include one or more settings for service(s). For example, the one or more parameter(s) 12P may include one or more privacy settings for location services, e.g., so as to govern which location services clients are allowed or are not allowed to access location information for the wireless communication device 12, as specified by 3GPP TS 23.273 v17.1.0 Section 5.4. Alternatively or additionally, the parameter(s) 12P may include parameter(s) that indicate user consent for a service. The setting(s) in this and other cases may be configured locally at the wireless communication device 12 by a user of the wireless communication device 12. Regardless of the type of the parameter(s) 12P, any change to the parameter(s) 12P at the wireless communication device 12 (e.g., at the initiation of the device's user) may need to be propagated to the home network 10.

Some embodiments herein accordingly introduce a home network parameter update procedure 14 to update the wireless communication device's home network 10 with the one or more parameters 12P, i.e., to update the home network 10 with new value(s) for the respective parameter(s) 12P. The home network parameter update procedure 14 may be initiated and/or triggered by the wireless communication device 12 itself, e.g., as opposed to having to be triggered by the home network 10. For example, the wireless communication device 12 may trigger the home network parameter update procedure responsive to detecting a change in at least one of the parameter(s) 12P, e.g., by the device's user. Or, the wireless communication device 12 may trigger the home network parameter update procedure responsive to detecting a change in an association between a permanent equipment identifier (PEI) and a subscription permanent identifier (SUPI) associated with the wireless communication device 12, e.g., due to the user changing the Subscriber Identity Module (SIM) inserted into the wireless communication device 12. Regardless of what triggers the home network parameter update procedure 14, though, the home network parameter update procedure 14 in these and other embodiments may be independent from, and/or be performable separately from, a procedure for updating the wireless communication device 12 with a set of parameters stored at the home network 10, e.g., independent from and/or performable separately from a User Equipment (UE) Parameter Update (UPU) procedure or a Steering of Roaming (SoR) procedure as specified in 3GPP TS 23.502 and TS 33.501. Accordingly, the home network parameter update procedure 14 according to these embodiments can be efficiently used to update the home network 10 with the parameter(s) 12P, even if the home network 10 does not need to update the wireless communication device 12 with parameter(s) stored at the home network 10. Generally, then, the home network parameter update procedure 14 may advantageously provide a way to update the wireless communication device's home network 10 with parameter(s) 12P at the wireless communication device 12, in a way that is efficient, with minimal signaling overhead impact.

More particularly, FIG. 1 shows that, as part of the home network parameter update procedure 14, the wireless communication device 12 transmits a message 20 (e.g., a Non-Access Stratum, NAS, message) to the home network 10, in order to update the home network 10 with the parameter(s) 12P. The message 20 in this regard includes the parameter(s) 12P. For example, the message 20 may carry a home network parameter update data container that contains the parameter(s) 12P. In some embodiments as shown, this message 20 is the first message in the home network parameter update procedure 14. In these and other embodiments, then, the wireless communication device 12 may initiate the home network parameter update procedure 14 by transmitting the message 20 to the home network 10. Note here that the home network parameter update procedure 14 in some embodiments involves or is associated with a sequence of multiple messages in time, with the message 20 occurring earliest in time amongst the multiple messages that are part of the home network parameter update procedure 14.

FIG. 1, for example, shows that in some embodiments the home network parameter update procedure 14 involves the wireless communication device 12 first transmitting the message 20 to the home network 10 and then involves the home network 10 transmitting message 30 to the wireless communication device 12. This latter message 30 may for example include an acknowledgement 30A of receipt by the home network 10 of the parameter(s) 12P sent by the wireless communication device 12 and/or include parameter(s) 30P to be updated by the wireless communication device 10. The parameter(s) 30P that the home network 10 may send for update by the wireless communication device 10 may for instance include routing indicator data and/or default configured network slice selection assistance information (NSSAI).

Regardless, this example demonstrates that, as part of the home network parameter update procedure 14, the wireless communication device 12 in some embodiments sends the message 20 to the home network 10 to update the home network 10 with the parameter(s) 12P before the home network 10 sends message 30 to the wireless communication device 12 to acknowledge reception of the parameter(s) 12P and/or to update the wireless communication device 12 with parameter(s) 30P.

In any event, in some embodiments, the home network parameter update procedure 14 is performed after registration with the home network 10. By performing the home network parameter update procedure 14 only after the registration procedure, some embodiments avoid increasing message overhead for all registration requests. Moreover, in these and other embodiments, then, the wireless communication device 12 as shown in FIG. 1 may perform an authentication and key agreement (AKA) procedure 18 with the home network 10 before performing the home network parameter update procedure 14, e.g., where the AKA procedure 18 may be performed during or as part of registration with the home network 10. Performing the AKA procedure 18 before the home network parameter update procedure 14 may facilitate protection of message(s) in the home network parameter update procedure 14.

In this regard, in some embodiments, the wireless communication device 12 generates key material 22 during the AKA procedure 18 with the home network 10. The key material 22 may for example include a cryptographic key, e.g., a key Kausf as described herein. The wireless communication device 12 in these embodiments may protect the parameter(s) 12P in the message 20 using the key material 22, e.g., by protecting the message 20 as a whole or by selectively protecting the parameter(s) 12P. The wireless communication device 12 may for example confidentiality protect (e.g., via encryption) and/or integrity protect the parameter(s) 12P in the message 20 using the key material 22.

With regard to integrity protection, for instance, the wireless communication device 12 may generate integrity protection information 26 (e.g., a message authentication code, MAC, such as a message authentication code HoPU-MAC-QUE as described herein) from the parameter(s) 20P and the key material 22, and include that integrity protection information 26 in the message 20. In some embodiments, the wireless communication device 12 may generate the integrity protection information 26 also from freshness information associated with the key material 22. For example, the freshness information may be a counter, such as a counter_{HOPU} as described herein. In this case, the wireless communication device 12 may monotonically increment the counter each time the wireless communication device 12 calculates integrity protection information 26 from the key material 22. Regardless, with the parameter(s) 12P integrity protected in this way, the home network 10 can check or verify the integrity of the parameter(s) 20P received using the integrity protection information 26. For example, the home network 10 may correspondingly obtain key material 22 from the AKA procedure 18 and verify the integrity of the received parameter(s) 12P using the parameter(s) 12P and the key material 22, and possibly also the freshness information as well, e.g., verifying the freshness of the parameter(s) 12P may be performed as part of verifying the integrity of the parameter(s) 12P received. The home network 10 can then update the parameter(s) 12P in the home network 10 responsive to verifying the integrity of the received parameter(s) 12P.

Note that, in some embodiments as shown, the message 30 transmitted by the home network 10 to the wireless communication device 12 may be protected by the same or different key material 22, e.g., in a similar way as described above for message 20.

Note further that some or all of the functionality generally described above as being performed by the home network 10 may be performed by network equipment 24 shown in FIG. 1. The network equipment 24 may comprise one or more network nodes, such as may implement an Access and Mobility Function (AMF), a Unified Data Management (UDM) function, and/or an Authentication Server Function (AUSF).

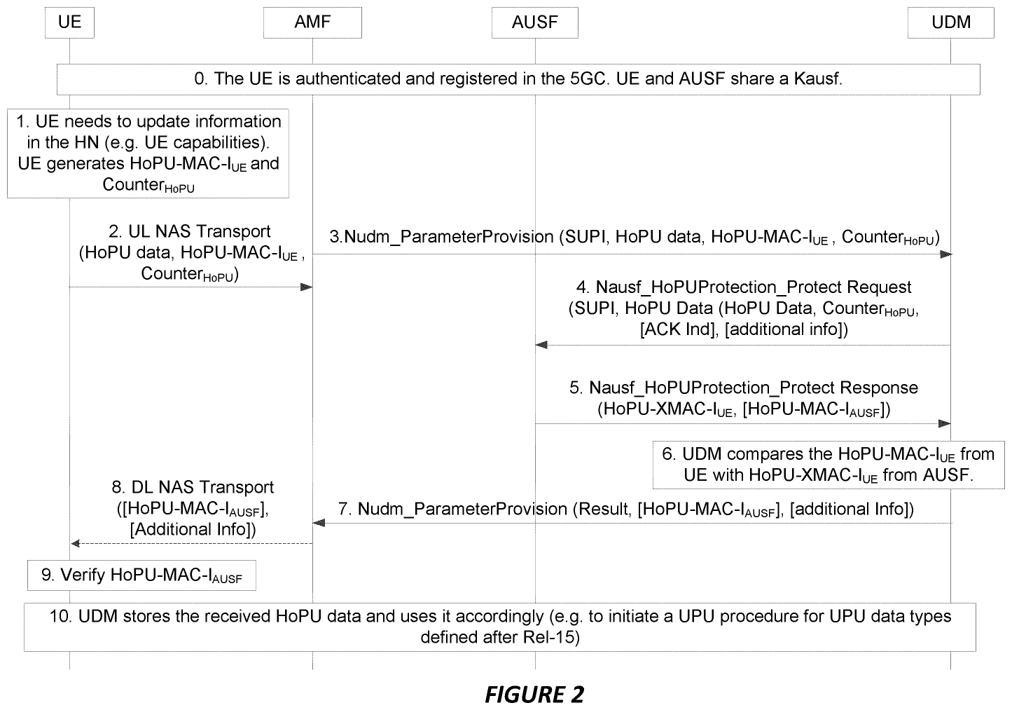

FIG. 2 shows one example of the home network parameter update (HoPU) procedure 14 in a context where the home network 10 is a 5G network according to some embodiments. In this case shown in FIG. 2, a user equipment (UE) exemplifies the wireless communication device 12 in FIG. 1, and the home network 10 in relevant part includes an AMF, AUSF, and UDM.

Step 0. The UE is authenticated and registered in the 5G Core (5GC), e.g., using an Authentication and Key Agreement (AKA) procedure. As a result, the UE and AUSF share key material 22 in the form of a key K_{AUSF}. The AUSF and the UE shall associate freshness information in the form of a counter (e.g. a 16-bit counter) Counter_{HoPU} with the key K_{AUSF}. The AUSF and the UE shall maintain the Counter_{HoPU} for the lifetime of the K_{AUSF}.

Step 1. The UE decides to update its home network 10 with one or more parameters 12P (e.g. in the form of location privacy setting(s). The one or more parameters 12P to be updated via the HoPU procedure are referred to generally as HoPU data. The UE generates a HoPU data container that contains the HoPU data. The UE also generates integrity protection information 26 for the HoPU data in the form of a HoPU-MAC-I_{UE}, using Counter_{HoPU} as freshness input. The UE increments the Counter_{HoPU} for every new computation of the HoPU-MAC-I_{UE}. If the UE decides that the home network 10 is to acknowledge the successful reception of the HoPU data, the UE includes an Acknowledgment (ACK) Indicator within the HoPU data container.

Step 2. The UE sends the HoPU data container to the AMF in a message 20 that in this example takes the form of a Non-Access Stratum (NAS) message, e.g., an uplink (UL) NAS Transport message or a NAS Uplink Request in an N1 NAS message. In the NAS message, the UE also includes HoPU-MAC-I_{UE}, the Counter_{HoPU} used for MAC (i.e., HPU-MAC-I_{UE}) generation and ACK indication if the UE decides that the home network 10 is to acknowledge the successful security check of the received HoPU data. Note here that the HoPU data container is distinguishable from a UPU data container usable in the UPU procedure, such that the HoPU procedure is independent of the UPU procedure/service. Some embodiments thereby avoid re-use of the UPU service and parameters and correspondingly avoid interfering with the already defined use of these parameters and services.

Step 3. The AMF invokes a Nudm_ParameterProvision_Update service operation towards the UDM to update HoPU data in the UDM. The AMF in this regard transmits a Nudm_ParameterProvision message to the UDM. In the Nudm_ParameterProvision message, the AMF includes the HoPU data, the HoPU-MAC-I_{UE}, and the Counter_{HoPU} used for MAC (i.e., HoPU-MAC-I_{UE}) generation.

Step 4. The UDM invokes a Nausf_HoPUProtection service operation by transmitting a Nausf_HoPUProtection_Protect Request message to the AUSF. In the Nausf_HoPUProtection_Protect Request message, the UE includes the UE ID (i.e., SUPI), HoPU data container (e.g. UE Location Privacy setting), HoPU-MAC-I_{UE}, and the Counter_{HoPU} for checking HoPU-MAC-I_{UE}. If the HoPU data container included an ACK Indicator, the UDM also sends an ACK indication to the AUSF. If the HoPU procedure is extended to protect any parameter(s) 30 that the home network 10 may want to provide to the UE within the HoPU ACK response, the UDM may include “additional information” in the request to the AUSF.

Step 5. The AUSF checks the freshness of Counter_{HoPU} and shall only accept Counter_{HoPU} value that is greater than stored Counter_{HoPU} value. The AUSF then generates expected integrity protection information in the form of HoPU-XMAC-I_{UE} corresponding to the HoPU data container with the received Counter_{HoPU}. If the UDM included an ACK indicator, the AUSF also generates an HoPU-MAC-I_{AUSF}. If the UDM included “additional information” in the request, the AUSF uses this “additional information” for the computation of the HoPU-MAC-I_{AUSF}. The AUSF replies to the UDM including the HoPU-XMAC-I_{UE} and optionally the HoPU-MAC-I_{AUSF} if the UDM included the ACK indication in the request.

Step 6. The UDM compares the HoPU-MAC-I_{UE} from the UE with the HoPU-XMAC-I_{UE} from the AUSF. If the validation result of HoPU-MAC-I_{UE} is successful, the UDM stores or updates the UE HoPU data in the Unified Data Repository (UDR) by invoking a Nudr_DM_Update (SUPI, Subscription Data) service operation accordingly. Here, SUPI stands for Subscription Permanent Identifier.

Alternatively, although not shown, validation of the HoPU-MAC-I_{UE} may be executed by the AUSF if the UDM provides the HoPU-MAC-I_{UE} to the AUSF in the request of step 5. The AUSF could then compare the HoPU-MAC-I_{UE} from the UDM with the locally generated HoPU-XMAC-I_{UE} and provide a success or unsuccessful result to the UDM in step 5.

Step 7. The UDM send Nudm_ParameterProvision_Update response to the AMF. If ACK indication is received from the UE in step 3, the UDM includes also HoPU-MAC-I_{AUSF} and potential additional information that is used in HoPU-MAC-I_{AUSF} calculation.

Step 8. The AMF sends the HoPU data response to the UE via N1 NAS message. The AMF includes HoPU-MAC-I_{AUSF} and potential additional info received from the UDM in step 7.

Step 9. The UE calculates HoPU-XMAC-I_{AUSF} and validates the HPU-XMAC-I_{AUSF} matching with the received HPU-MAC-I_{AUSF}.

Note that this HoPU procedure enables integrity protection of UE provided data to the HN home network 10, e.g. UE privacy setting. This guards against a misbehaving AMF ignoring the UE request and providing a positive response to the UE without even initiating the parameter update with the UDM, or initiating the parameter update in the UDM/UDR with tampered or outdated parameter(s) 12P.

Note further that the HoPU procedure can be triggered by the UE at any time after the registration is completed. This also minimizes dependencies and issues with the Registration procedure.

Note further that the HoPU procedure enables the UE to ask for acknowledgement of safe delivery of HoPU data in the home network 10. The home network 10 may validate the freshness of UE provided data request and thereby mitigate the risk of replayed or tampered UE provided data. The HoPU procedure also enables the home network 10 to send additional information (e.g., parameter(s) 30) in an acknowledgement of a UE-triggered request with integrity protection.

Consider now additional details concerning Counter_{HoPU} according to some embodiments. In some embodiments, the AUSF shall initialize the Counter_{HoPU} to 0x00 0x00 when the K_{AUSF} is derived. The UE shall initialize the Counter_{HoPU} to 0x00 0x01 when the K_{AUSF} is derived. The UE shall set the Counter_{HoPU} to 0x00 0x02 after the first calculated HoPU-MAC-I_{UE}, and monotonically increment it for each additional calculated HoPU-MAC-I_{UE}. The UE shall suspend the HoPU service protection, if the Counter_{HoPU} associated with the K_{AUSF} of the UE, is about to wrap around. When a fresh K_{AUSF} is generated for the UE, the Counter_{HoPU} at the UE is reset to 0x00 0x01 as defined above and the UE shall resume the HoPU service protection. The UE may trigger a registration/authentication to get a fresh K_{AUSF} if the Counter_{HoPU} is about to wrap around.

Consider now additional details for calculation of HoPU-XMAC-I_{UE} and HoPU-MAC-QUE according to some embodiments. When deriving a HoPU-MAC-QUE and HoPU-XMAC-I_{UE} from K_{AUSF}, the following parameters shall be used to form the input S to the KDF.
FC=XX,
P0=HoPU data (e.g. UE privacy settings),
L0=length of P0
P1=Counter_{HoPU}
L1=length of Counter_{HoPU}

The input key Key shall be K_{AUSF}. Here, XX may be any value specified by 3GPP.

Consider now additional details for calculation of HoPU-XMAC-I_{AUSF} and HoPU-MAC-I_{AUSF} according to some embodiments. When deriving HoPU-MAC-I_{AUSF} and HoPU-XMAC-I_{AUSF} from K_{AUSF}, the following parameters shall be used to form the input S to the KDF.
FC=xx,
P0=0x01 (HoPU Acknowledgement: Verified the HoPU data successfully)
L0=length of P0
P1=Counter_{HoPU}
L1=length of Counter_{HoPU}
P2=Additional info
L2=length of P2

The input key Key shall be K_{AUSF}.

Consider further aspects for triggering the home network parameter update procedure 14 according to some embodiments. As described, the home network parameter update procedure 14 is fully controlled and triggered by the UE. In some cases, the UE will trigger the update of parameter(s) 12P in the home network 10 only when the parameter(s) 12P change at the UE side. For example, the UE will trigger the HoPU procedure when the privacy settings for Location Services (LCS) are changed at the UE side. In this case, the UDM will store the privacy settings for LCS for the UE and will provide it to network functions (NFs) requesting it when applicable.

However, in other embodiments, the home network parameter update procedure 14 may be triggered by a change of the UE and/or Universal Subscriber Identity Module (USIM) itself. For example, when a user changes its USIM from one mobile equipment (ME) to another, the UE capabilities associated with the inserted USIM will change. This corresponds to the case of SIM swap (i.e. when the USIM/SUPI inserted is changed by another USIM/SUPI) and also case of software upgrades of the ME where the Software Version part of the Permanent Equipment Identifier (PEI) (PEI-SV) will change. In some embodiments, then, the UE triggers the HoPU procedure whenever the UE detects that the PEI-SUPI association within the UE changes in order for the home network 10 to be aware of the UE capabilities of the new ME/PEI associated to the SUPI. It is also proposed that the UDM in the home network 10 stores the received UE capabilities within the HoPU data per SUPI-PEI association. This will allow the UDM to execute corresponding procedures (e.g., UPU procedure) depending on the received UE capabilities over the HoPU procedure.

Generally, then, some embodiments define a new procedure 14 for the UE to update information in the home network 10 in a secure way. This home network parameter update procedure 14 may operate independently of a UPU procedure and in the opposite direction (i.e. from UE to HN). UE provided parameters via HoPU may be protected also using a new AUSF service (Nausf_HoPUProtection) and corresponding new parameters (e.g. HoPU-MAC-I_{UE}, Counter_{HoPU}, Etc, . . . ).

Note that some embodiments are exemplified using the update of UE privacy settings for Location services, but the embodiments may be used for the update of any other UE parameters that the UE needs to update in the home network 10 (e.g., user consent for other services, UE capabilities for UPU/SoR).

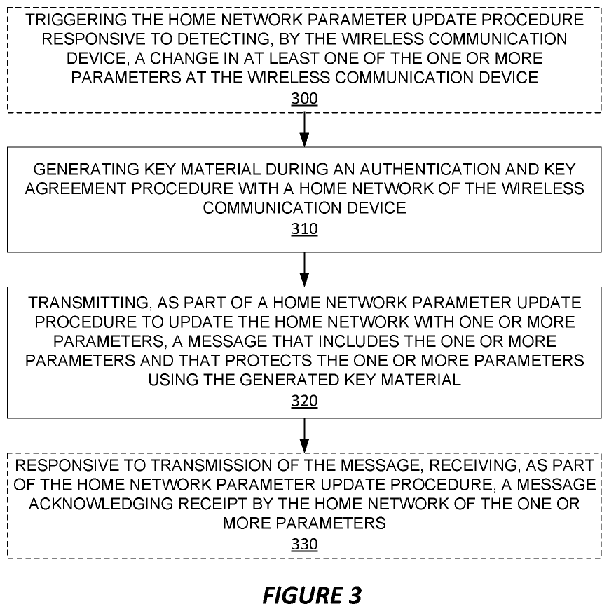

In view of the modifications and variations herein, FIG. 3 depicts a method performed by the wireless communication device 12 in accordance with particular embodiments. The method includes generating key material 22 during an authentication and key agreement procedure 18 with a home network 10 of the wireless communication device 12 (Block 310). The method also comprises transmitting, as part of a home network parameter update procedure 14 to update the home network 10 with one or more parameters 12P, a message 20 that includes the one or more parameters 12P and that protects the one or more parameters 12P using the generated key material 22 (Block 320).

In some embodiments, the home network parameter update procedure 14 is initiated and/or triggered by the wireless communication device 12.

In some embodiments, the transmitted message 20 is the first message in the home network parameter update procedure 14.

In some embodiments, the home network parameter update procedure 14 is independent from, and/or is performable separately from, a user equipment, UE, parameter update, UPU, procedure for updating the wireless communication device 12 with a set of parameters stored at the home network 10.

In some embodiments, the one or more parameters 12P are confidentiality protected and/or integrity protected using the generated key material 22.

In some embodiments, the one or more parameters 12P include one or more privacy settings for location services.

In some embodiments, the one or more parameters 12P include one or more parameters that govern which location services clients are or are not allowed to access location information for the wireless communication device 12.

In some embodiments, the one or more parameters 12P include one or more capabilities of the wireless communication device 12. In one or more of these embodiments, the one or more capabilities include one or more capabilities for steering of roaming, SoR, and/or one or more capabilities for UE parameter update, UPU.

In some embodiments, the one or more parameters 12P include one or more parameters that indicate user consent for a service.

In some embodiments, the key material 22 is generated during authentication and registration of the wireless communication device 12 with the home network 10, and the home network parameter update procedure 14 is performed after registration of the wireless communication device 12 with the home network 10.

In some embodiments, the one or more parameters 12P are included in a home network parameter update data container carried within the message 20.

In some embodiments, the message 20 is a non-access stratum, NAS, message.

In some embodiments, the message 20 is transmitted to network equipment 24 implementing an access and mobility function, AMF.

In some embodiments, the message 20 further includes integrity protection information 26 that integrity protects the one or more parameters 12P. In one or more of these embodiments, the method further comprises generating the integrity protection information 26 from the one or more parameters 12P and from the key material 22. In one or more embodiments, the integrity protection information 26 comprises a message authentication code HoPU-MAC-QUE. In one or more embodiments, the method further comprises generating freshness information associated with the key material 22. In this case, the integrity protection information 26 is generated from the freshness information. In one or more embodiments, the freshness information comprises a counter. In one or more embodiments, the method further comprises monotonically incrementing the counter each time the wireless communication device 12 calculates integrity protection information 26 from the key material 22.

In some embodiments, the method further comprises triggering the home network parameter update procedure 14 responsive to detecting, by the wireless communication device 12, a change in at least one of the one or more parameters 12P at the wireless communication device 12 (Block 300).

In other embodiments not shown, the method further comprises triggering the home network parameter update procedure 14 responsive to detecting, by the wireless communication device 12, a change in an association between a permanent equipment identifier and a subscription permanent identifier associated with the wireless communication device 12.

In some embodiments, the key material 22 used to protect the one or more parameters 12P includes a key Kausf.

In some embodiments, the message 20 further includes a request that the home network 10 acknowledge receipt of the one or more parameters.

In some embodiments, the method further comprises, responsive to transmission of the message 20, receiving, as part of the home network parameter update procedure 14, a message 30 acknowledging receipt by the home network 10 of the one or more parameters 12P (Block 330). In one or more of these embodiments, the received message 30 also includes one or more parameters 30P to be updated at the wireless communication device 12. In one or more of these embodiments, the one or more parameter 30P included in the received message include routing indicator data and/or default configured network slice selection assistance information. In one or more embodiments, the one or more parameters 30P included in the received message 30 are protected using the generated key material 22. In one or more embodiments, the method further comprises decrypting, and/or verifying an integrity of, and/or verifying a freshness of, the one or more parameters 30P in the received message 30 using the generated key material 22. In one or more embodiments, the method further comprises updating the one or more parameters included in the received message at the wireless communication device 11 responsive to successfully verifying the integrity of the one or more parameters included in the received message 30.

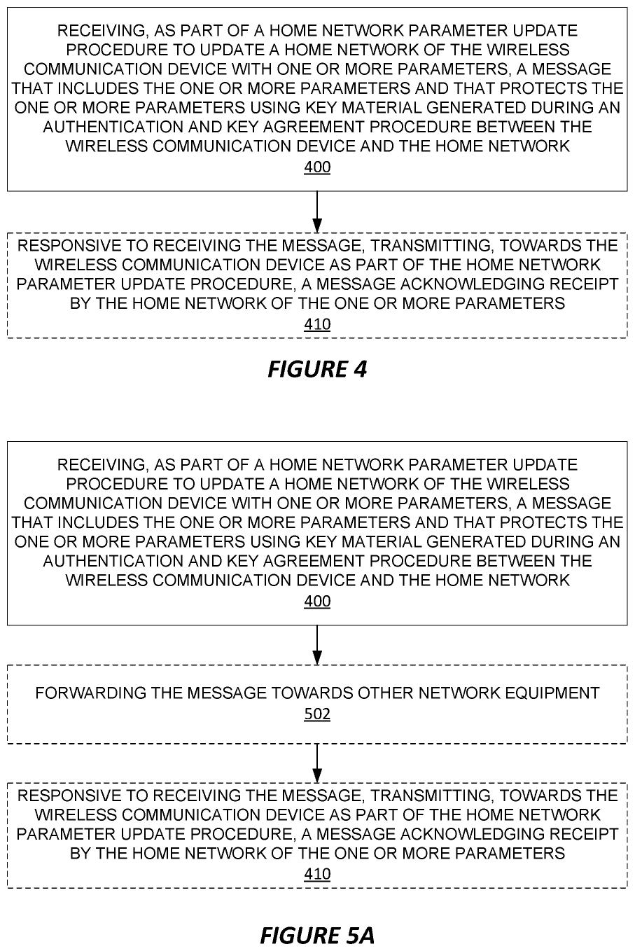

FIG. 4 depicts a method performed by network equipment 24 in accordance with other particular embodiments. The method comprises receiving, as part of a home network parameter update procedure 14 to update a home network 10 of the wireless communication device 12 with one or more parameters 12P, a message that includes the one or more parameters 12P and that protects the one or more parameters 12P using key material 22 generated during an authentication and key agreement procedure 18 between the wireless communication device 12 and the home network 10.

In some embodiments, for example, the received message is the message 20 shown in FIG. 1, e.g., as transmitted by the wireless communication device 12. In this case, the network equipment 24 may for example implement an AMF, e.g., the AMF in FIG. 2, and the received message may be a NAS message.

In other embodiments, the received message is received from other network equipment. For example, in one embodiment the network equipment implementing the method in FIG. 4 implements a UDM, e.g., the UDM in FIG. 2. In this case, the message may be received from other network equipment, e.g., implementing an AMF. In these and other embodiments, then, the received message in the method of FIG. 4 may be a Nudm_ParameterProvision message, e.g., as shown in FIG. 2.

In some embodiments, the home network parameter update procedure 14 is initiated and/or triggered by the wireless communication device 12.

In some embodiments, the received message is the first message in the home network parameter update procedure 14.

In some embodiments, the home network parameter update procedure 14 is independent from, and/or is performable separately from, a user equipment, UE, parameter update, UPU, procedure for updating the wireless communication device 12 with a set of parameters 30P stored at the home network 10.

In some embodiments, the one or more parameters 12P are confidentiality protected and/or integrity protected using the generated key material 22.

In some embodiments, the one or more parameters 12P include one or more privacy settings for location services.

In some embodiments, the one or more parameters 12P include one or more parameters that govern which location services clients are or are not allowed to access location information for the wireless communication device 12.

In some embodiments, the one or more parameters 12P include one or more capabilities of the wireless communication device. In one or more of these embodiments, the one or more capabilities include one or more capabilities for steering of roaming, SoR, and/or one or more capabilities for UE parameter update, UPU.

In some embodiments, the one or more parameters 12P include one or more parameters that indicate user consent for a service.

In some embodiments, the key material 22 is generated during authentication and registration of the wireless communication device 12 with the home network 10, and the home network parameter update procedure 14 is performed after registration of the wireless communication device with the home network 10.

In some embodiments, the one or more parameters 12P are included in a home network parameter update data container carried within the message.

In some embodiments, the message further includes integrity protection information 26 that integrity protects the one or more parameters 12P. In one or more of these embodiments, the integrity protection information 26 is generated from the one or more parameters 12P and from the key material 22. In one or more embodiments, the integrity protection information 26 comprises a message authentication code HoPU-MAC-I_{UE}. In one or more embodiments, the message further includes a freshness information associated with the key material 22. In one or more embodiments, the method further comprises generating freshness information associated with the key material 22. In this case, the integrity protection information 26 is generated from the freshness information. In one or more embodiments, freshness information comprises a counter that is monotonically incremented each time the wireless communication device 12 calculates integrity protection information from the key material 22.

In some embodiments, the home network parameter update procedure 14 is triggered responsive to detection, by the wireless communication device 12, of a change in at least one of the one or more parameters 12P at the wireless communication device 12.

In some embodiments, the home network parameter update procedure 14 is triggered responsive to detection, by the wireless communication device 12, of a change in an association between a permanent equipment identifier and a subscription permanent identifier associated with the wireless communication device 12.

In some embodiments, the message further includes a request that the home network 10 acknowledge receipt of the one or more parameters 12P.

In some embodiments, the message is a non-access stratum, NAS, message.

In some embodiments, the network equipment implements an access and mobility function, AMF.

In some embodiments, the method further comprises, responsive to receiving the message, transmitting, towards the wireless communication device 12 as part of the home network parameter update procedure 14, a message 30 acknowledging receipt by the home network 10 of the one or more parameters 12P (Block 410). In one or more of these embodiments, the transmitted message 30 also includes one or more parameters 30P to be updated at the wireless communication device 12. In one or more of these embodiments, the one or more parameter 12P included in the transmitted message include routing indicator data and/or default configured network slice selection assistance information. In one or more embodiments, the one or more parameters 30P included in the transmitted message 30 are protected using the generated key material 22.

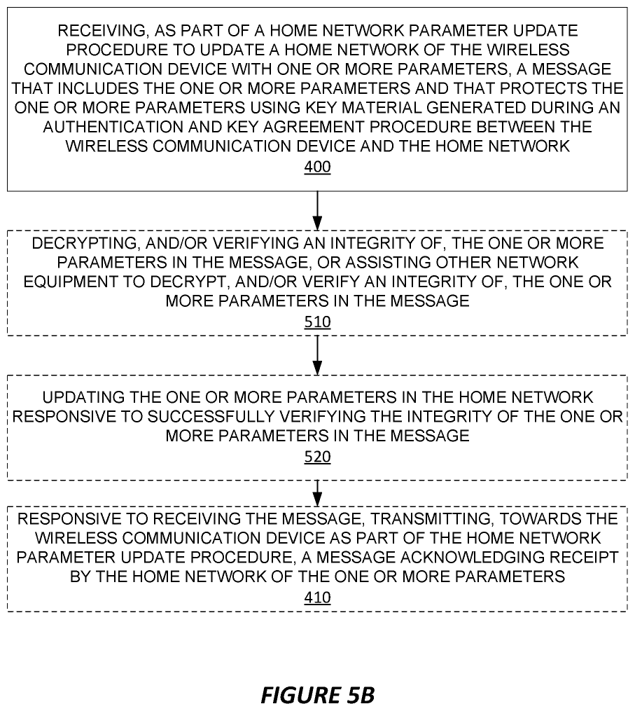

FIG. 5A shows additional aspects of the method in FIG. 4 in some embodiments. As shown, in some embodiments, such as where the network equipment 24 implements an AMF, the method may further comprise forwarding the received message towards other network equipment. In one or more of these embodiments, the other network equipment implements a user data management, UDM, function. In this case, the received message in the method of FIG. 5A may be a Nudm_ParameterProvision message, e.g., as shown in FIG. 2. And forwarding the received message may involve forwarding the received message in, or in the form of, a Nudm_ParameterProvision message shown in FIG. 2.

FIG. 5B shows additional aspects of the method in FIG. 4 in yet other embodiments. In one such embodiment, the network equipment 24 implements a UDM, and the received message is the Nudm_ParameterProvision message shown in FIG. 2. Regardless, in these and other embodiments, the method may further comprise decrypting, and/or verifying an integrity of, the one or more parameters 12P in the message, or assisting other network equipment (e.g., AUSF) to decrypt, and/or verify an integrity of, the one or more parameters in the message (Block 510). In one or more of these embodiments, the method may further comprise updating the one or more parameters 12P in the home network 10 responsive to successfully verifying the integrity of the one or more parameters in the message.

In one or more embodiments, the message includes integrity protection information that integrity protects the one or more parameters. In this case, verifying the integrity of the one or more parameters in the message comprises requesting an authentication server for expected integrity protection information, and comparing the integrity protection information included in the message with the expected integrity protection information received from the authentication server.

In other embodiments, the message includes integrity protection information that integrity protects the one or more parameters, and verifying the integrity of the one or more parameters in the message comprises transmitting the received message to an authentication server, and receiving, from the authentication server, an indication of whether or not the integrity of the one or more parameters in the message is successfully verified.

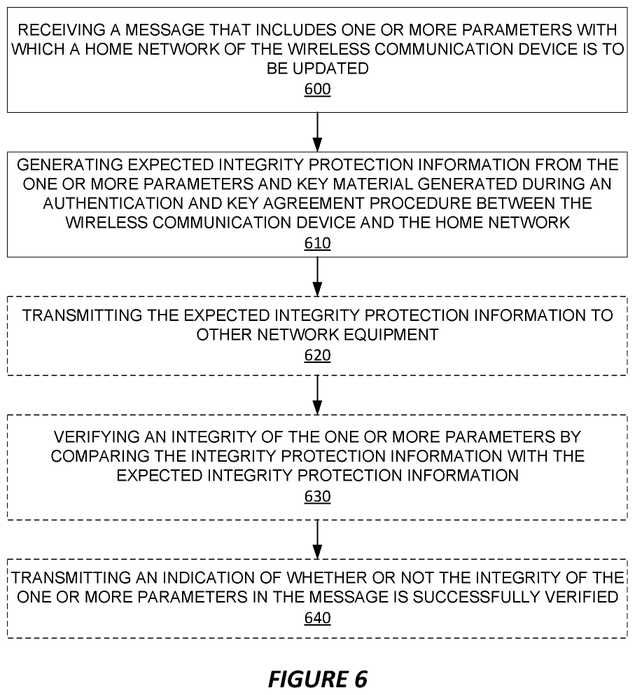

FIG. 6 depicts a method performed by network equipment 24 (e.g., implementing an AUSF) in accordance with yet other embodiments. The method includes receiving a message that includes one or more parameters 12P with which a home network 10 of the wireless communication device 12 is to be updated (Block 600). The received message may for example be an Nausf_HoPUProtection_Protect Request message, e.g., as shown in step 4 of FIG. 2. Regardless, the method further comprises generating expected integrity protection information from the one or more parameters 12P and key material 22 generated during an authentication and key agreement procedure 18 between the wireless communication device 12 and the home network 10 (Block 610). For example, in some embodiments, the expected integrity protection information is an expected MAC, e.g., HoPU-XMAC-I_{UE} shown in FIG. 2.

In any event, in some embodiments, the method further comprises transmitting the expected integrity protection information to other network equipment, e.g., UDM (Block 620). FIG. 2 for instance exemplifies this in step 5.

In other embodiments, the method further comprises verifying an integrity of the one or more parameters 12P by comparing integrity protection information in the received message with the expected integrity protection information (Block 630). In this case, the method may also comprise transmitting an indication of whether or not the integrity of the one or more parameters 12P in the message is successfully verified ((Block 640).

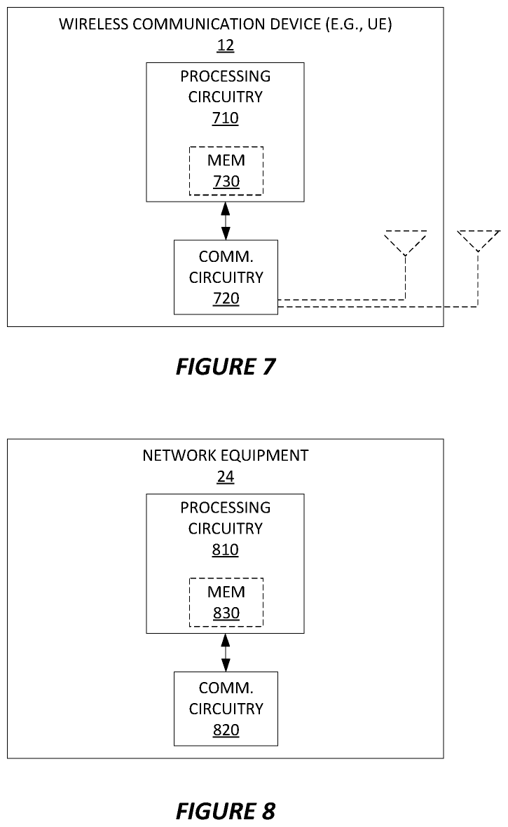

FIG. 7 illustrates a wireless communication device 12 as implemented in accordance with one or more embodiments. As shown, the wireless communication device 12 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the wireless device 700. The processing circuitry 710 is configured to perform processing described above, e.g., in FIG. 3, such as by executing instructions stored in memory 730. The processing circuitry 710 in this regard may implement certain functional means, units, or modules.

FIG. 8 illustrates network equipment 24 as implemented in accordance with one or more embodiments. As shown, the network equipment 24includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 4, 5A, 5B, and/or 6, such as by executing instructions stored in memory 830. The processing circuitry 810 in this regard may implement certain functional means, units, or modules.

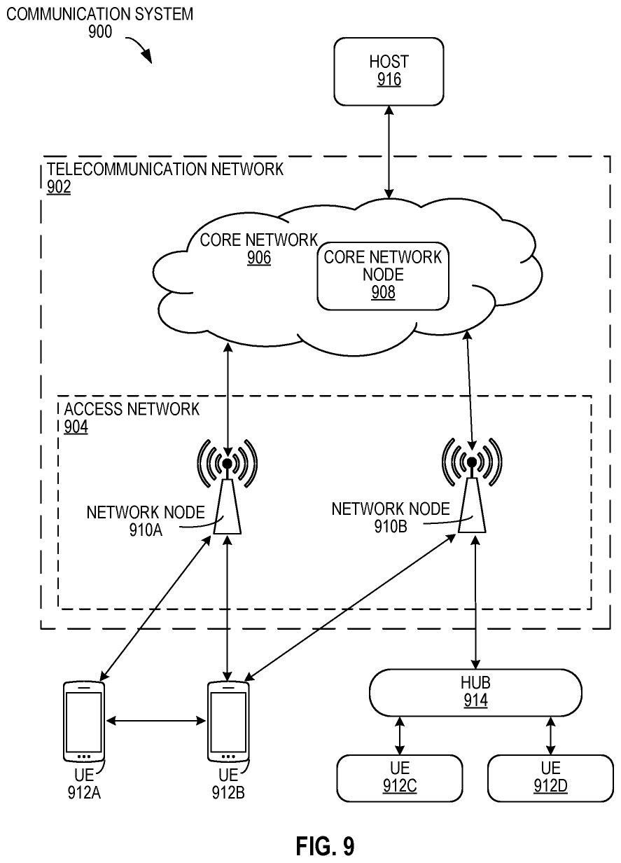

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

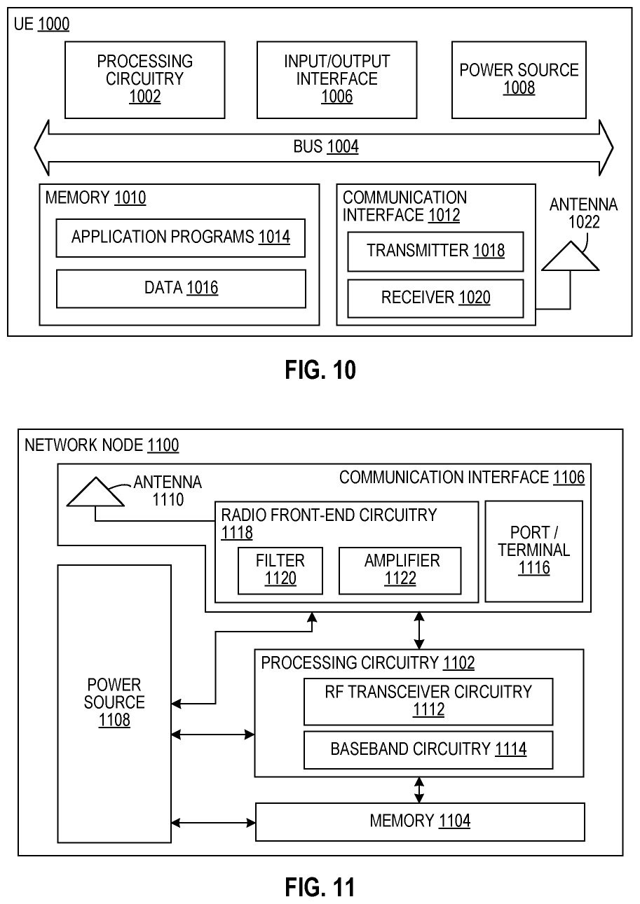

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

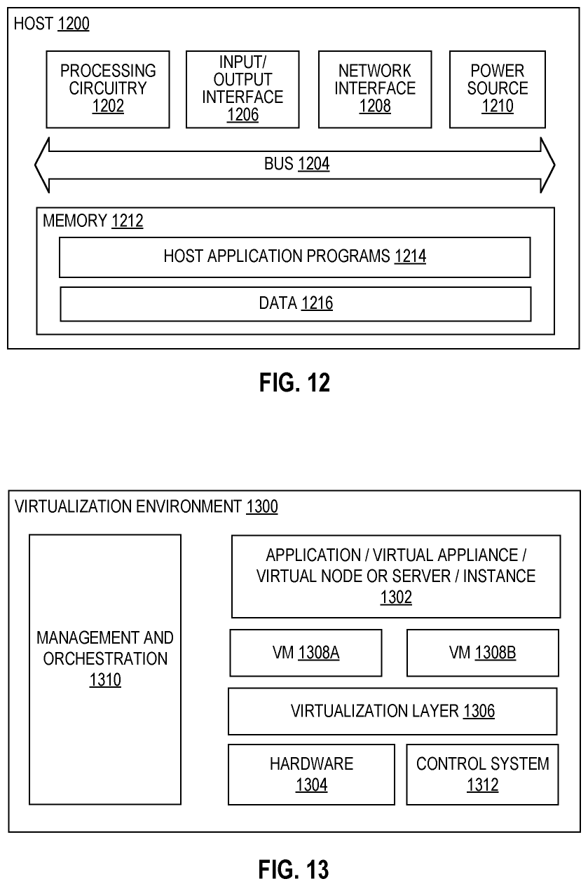

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

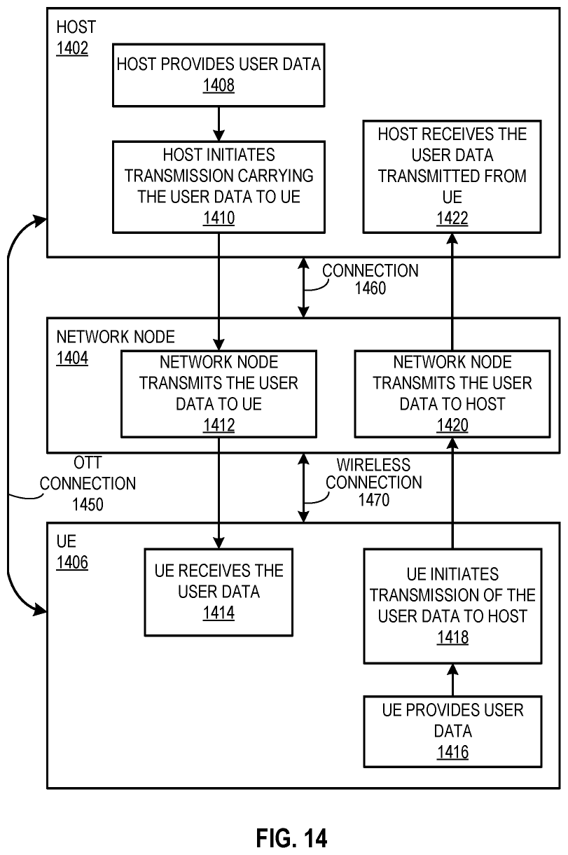

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device, the method comprising:
generating key material during an authentication and key agreement procedure with a home network of the wireless communication device; and
transmitting, as part of a home network parameter update procedure to update the home network with one or more parameters, a message that includes the one or more parameters and that protects the one or more parameters using the generated key material.

A2. The method of embodiment A1, wherein the home network parameter update procedure is initiated and/or triggered by the wireless communication device.

A3. The method of any of embodiments A1-A2, wherein the transmitted message is the first message in the home network parameter update procedure.

A4. The method of any of embodiments A1-A3, wherein the home network parameter update procedure is independent from, and/or is performable separately from, a user equipment, UE, parameter update, UPU, procedure for updating the wireless communication device with a set of parameters stored at the home network.

A5. The method of any of embodiments A1-A4, wherein the one or more parameters are confidentiality protected and/or integrity protected using the generated key material.

A6. The method of any of embodiments A1-A5, wherein the one or more parameters include one or more privacy settings for location services.

A7. The method of any of embodiments A1-A6, wherein the one or more parameters include one or more parameters that govern which location services clients are or are not allowed to access location information for the wireless communication device.

A8. The method of any of embodiments A1-A7, wherein the one or more parameters include one or more capabilities of the wireless communication device.

A9. The method of embodiment A8, wherein the one or more capabilities include one or more capabilities for steering of roaming, SoR, and/or one or more capabilities for UE parameter update, UPU.

A10. The method of any of embodiments A1-A9, wherein the one or more parameters include one or more parameters that indicate user consent for a service.

A11. The method of any of embodiments A1-A10, wherein the key material is generated during authentication and registration of the wireless communication device with the home network, and wherein the home network parameter update procedure is performed after registration of the wireless communication device with the home network.

A12. The method of any of embodiments A1-A11, wherein the one or more parameters are included in a home network parameter update data container carried within the message.

A13. The method of any of embodiments A1-A12, wherein the message is a non-access stratum, NAS, message.

A14. The method of any of embodiments A1-A13, wherein the message is transmitted to a network node implementing an access and mobility function, AMF.

A15. The method of any of embodiments A1-A14, wherein the message further includes integrity protection information that integrity protects the one or more parameters.

A16. The method of embodiment A15, further comprising generating the integrity protection information from the one or more parameters and from the key material.

A17. The method of any of embodiments A14-A15, wherein the integrity protection information comprises a message authentication code HoPU-MAC-I_{UE}.

A18. The method of any of embodiments A14-A17, further comprising generating freshness information associated with the key material, and wherein the integrity protection information is generated from the freshness information.

A19. The method of embodiment A18, wherein the freshness information comprises a counter.

A20. The method of embodiment A19, further comprising monotonically incrementing the counter each time the wireless communication device calculates integrity protection information from the key material.

A21. The method of any of embodiments A1-A20, further comprising triggering the home network parameter update procedure responsive to detecting, by the wireless communication device, a change in at least one of the one or more parameters at the wireless communication device.

A22. The method of any of embodiments A1-A20, further comprising triggering the home network parameter update procedure responsive to detecting, by the wireless communication device, a change in an association between a permanent equipment identifier and a subscription permanent identifier associated with the wireless communication device.

A23. The method of any of embodiments A1-A22, wherein the key material used to protect the one or more parameters includes a key Kausf.

A24. The method of any of embodiments A1-A23, wherein the message further includes a request that the home network acknowledge receipt of the one or more parameters.

A25. The method of any of embodiments A1-A24, further comprising, responsive to transmission of the message, receiving, as part of the home network parameter update procedure, a message acknowledging receipt by the home network of the one or more parameters.

A26. The method of embodiment A25, wherein the received message also includes one or more parameters to be updated at the wireless communication device.

A27. The method of embodiment A26, wherein the one or more parameter included in the received message include routing indicator data and/or default configured network slice selection assistance information.

A28. The method of any of embodiments A25-A27, wherein the one or more parameters included in the received message are protected using the generated key material.

A29. The method of any of embodiments A25-A28, further comprising decrypting, and/or verifying an integrity of, and/or verifying a freshness of, the one or more parameters in the received message using the generated key material.

A30. The method of embodiment A29, further comprising updating the one or more parameters included in the received message at the wireless communication device responsive to successfully verifying the integrity of the one or more parameters included in the received message.

AA. The method of any of the previous embodiments, further comprising:
providing user data; and
forwarding the user data to a host via the transmission to the network node.

### Group B Embodiments

B1. A method performed by network equipment, the method comprising:
receiving, as part of a home network parameter update procedure to update a home network of the wireless communication device with one or more parameters, a message that includes the one or more parameters and that protects the one or more parameters using key material generated during an authentication and key agreement procedure between the wireless communication device and the home network.

B2. The method of embodiment B1, wherein the home network parameter update procedure is initiated and/or triggered by the wireless communication device.

B3. The method of any of embodiments B1-B2, wherein the received message is the first message in the home network parameter update procedure.

B4. The method of any of embodiments B1-B3, wherein the home network parameter update procedure is independent from, and/or is performable separately from, a user equipment, UE, parameter update, UPU, procedure for updating the wireless communication device with a set of parameters stored at the home network.

B5. The method of any of embodiments B1-B4, wherein the one or more parameters are confidentiality protected and/or integrity protected using the generated key material.

B6. The method of any of embodiments B1-B5, wherein the one or more parameters include one or more privacy settings for location services.

B7. The method of any of embodiments B1-B6, wherein the one or more parameters include one or more parameters that govern which location services clients are or are not allowed to access location information for the wireless communication device.

B8. The method of any of embodiments B1-B7, wherein the one or more parameters include one or more capabilities of the wireless communication device.

B9. The method of embodiment B8, wherein the one or more capabilities include one or more capabilities for steering of roaming, SoR, and/or one or more capabilities for UE parameter update, UPU.

B10. The method of any of embodiments B1-A9, wherein the one or more parameters include one or more parameters that indicate user consent for a service.

B11. The method of any of embodiments B1-B10, wherein the key material is generated during authentication and registration of the wireless communication device with the home network, and wherein the home network parameter update procedure is performed after registration of the wireless communication device with the home network.

B12. The method of any of embodiments B1-B11, wherein the one or more parameters are included in a home network parameter update data container carried within the message.

B13. The method of any of embodiments B1-B12, wherein the message further includes integrity protection information that integrity protects the one or more parameters.

B14. The method of embodiment B13, wherein the integrity protection information is generated from the one or more parameters and from the key material.

B15. The method of any of embodiments B13-B14, wherein the integrity protection information comprises a message authentication code HoPU-MAC-I_{UE}.

B16. The method of any of embodiments B13-B15, wherein the message further includes a freshness information associated with the key material.

B17. The method of embodiment B16, further comprising generating freshness information associated with the key material, and wherein the integrity protection information is generated from the freshness information.

B18 The method of embodiment B17, wherein the counter is monotonically incremented each time the wireless communication device calculates integrity protection information from the key material.

B19. The method of any of embodiments B1-B18, wherein the home network parameter update procedure is triggered responsive to detection, by the wireless communication device, of a change in at least one of the one or more parameters at the wireless communication device.

B20. The method of any of embodiments B1-B19, wherein the home network parameter update procedure is triggered responsive to detection, by the wireless communication device, of a change in an association between a permanent equipment identifier and a subscription permanent identifier associated with the wireless communication device.

B21. The method of any of embodiments B1-B20, wherein the message further includes a request that the home network acknowledge receipt of the one or more parameters.

B22. The method of any of embodiments B1-B21, wherein the message is a non-access stratum, NAS, message.

B23. The method of any of embodiments B1-B22, wherein the network equipment implements an access and mobility function, AMF.

B24. The method of any of embodiments B1-B23, further comprising forwarding the message towards other network equipment.

B25. The method of embodiment B24, wherein the other network equipment implements a user data management, UDM, function.

B26. The method of any of embodiments B1-B21, wherein the network equipment implements a user data management, UDM, function.

B27. The method of any of embodiments B1-B21 and B26, further comprising decrypting, and/or verifying an integrity of, the one or more parameters in the message.

B28. The method of embodiment B27, further comprising updating the one or more parameters in the home network responsive to successfully verifying the integrity of the one or more parameters in the message.

B29. The method of any of embodiments B27-B28, wherein the message includes integrity protection information that integrity protects the one or more parameters, wherein verifying the integrity of the one or more parameters in the message comprises:
requesting an authentication server for expected integrity protection information; and
comparing the integrity protection information included in the message with the expected integrity protection information received from the authentication server.

B30. The method of any of embodiments B27-B28, wherein the message includes integrity protection information that integrity protects the one or more parameters, wherein verifying the integrity of the one or more parameters in the message comprises:
transmitting the received message to an authentication server; and
receiving, from the authentication server, an indication of whether or not the integrity of the one or more parameters in the message is successfully verified.

B31. The method of any of embodiments B1-B21, wherein the network equipment implements an authentication server.

B32. The method of embodiment B31, wherein the message is received from another network node that implements a UDM function.

B33. The method of any of embodiments B31-B32, further comprising decrypting, and/or verifying an integrity of, the one or more parameters in the message.

B34. The method of embodiment B33, wherein the message includes integrity protection information that integrity protects the one or more parameters, wherein verifying the integrity of the one or more parameters in the message comprises:
calculating expected integrity protection information; and
comparing the integrity protection information included in the message with the expected integrity protection information.

B35. The method of any of embodiments B31-B32, further comprising assisting other network equipment to decrypt, and/or verify an integrity of, the one or more parameters in the message.

B36. The method of embodiment B35, wherein the message includes integrity protection information that integrity protects the one or more parameters, wherein said assisting comprises:
calculating expected integrity protection information; and
transmitting the expected integrity protection information to the other network equipment.

B37. The method of any of embodiments B1-B36, further comprising, responsive to receiving the message, transmitting, towards the wireless communication device as part of the home network parameter update procedure, a message acknowledging receipt by the home network of the one or more parameters.

B38. The method of embodiment B37, wherein the transmitted message also includes one or more parameters to be updated at the wireless communication device.

B39. The method of embodiment B38, wherein the one or more parameter included in the transmitted message include routing indicator data and/or default configured network slice selection assistance information.

B40. The method of any of embodiments B38-B39, wherein the one or more parameters included in the transmitted message are protected using the generated key material.

BB1. A method performed by network equipment, the method comprising:
receiving a message that includes one or more parameters with which a home network of the wireless communication device is to be updated; and
generating expected integrity protection information from the one or more parameters and key material generated during an authentication and key agreement procedure between the wireless communication device and the home network.

BB2. The method of embodiment B1, wherein the message is received as part of a home network parameter update procedure initiated and/or triggered by the wireless communication device.

BB3. The method of any of embodiments BB2, wherein the received message is the first message in the home network parameter update procedure.

BB4. The method of any of embodiments BB2-BB3, wherein the home network parameter update procedure is independent from, and/or is performable separately from, a user equipment, UE, parameter update, UPU, procedure for updating the wireless communication device with a set of parameters stored at the home network.

BB5. The method of any of embodiments BB1-BB4, wherein the one or more parameters are confidentiality protected and/or integrity protected using the key material.

BB6. The method of any of embodiments BB1-BB5, wherein the one or more parameters include one or more privacy settings for location services.

BB7. The method of any of embodiments BB1-BB6, wherein the one or more parameters include one or more parameters that govern which location services clients are or are not allowed to access location information for the wireless communication device.

BB8. The method of any of embodiments BB1-BB7, wherein the one or more parameters include one or more capabilities of the wireless communication device.

BB9. The method of embodiment BB8, wherein the one or more capabilities include one or more capabilities for steering of roaming, SoR, and/or one or more capabilities for UE parameter update, UPU.

BB10. The method of any of embodiments BB1-AB9, wherein the one or more parameters include one or more parameters that indicate user consent for a service.

BB11. The method of any of embodiments BB1-BB10, wherein the key material is generated during authentication and registration of the wireless communication device with the home network.

BB12. The method of any of embodiments BB1-BB11, wherein the one or more parameters are included in a home network parameter update data container carried within the message.

BB13. Reserved.

BB14. Reserved.

BB15. The method of any of embodiments BB13-BB14, wherein the expected integrity protection information comprises an expected message authentication code HoPU-XMAC-QUE.

BB16. The method of any of embodiments BB13-BB15, wherein the message further includes a freshness information associated with the key material.

BB17. The method of embodiment BB16, wherein the expected integrity protection information is generated also from the freshness information.

BB18 The method of embodiment BB17, wherein the freshness information includes a counter, wherein the counter is monotonically incremented each time the wireless communication device calculates integrity protection information from the key material.

BB19. The method of any of embodiments BB1-BB18, wherein the message is a Nausf_HoPUPortection_Protect Request message.

BB20. The method of any of embodiments BB1-BB19, further comprising transmitting the expected integrity protection information to other network equipment.

BB21. The method of embodiment BB20, wherein the other network equipment implements a UDM.

BB22. The method of any of embodiments BB20-BB21, wherein the expected integrity protection information is transmitted in a Nausf_HoPUPortection_Protect Response message.

BB23. The method of any of embodiments BB1-BB19, wherein the message also includes integrity protection information that protects the one or more parameters, and wherein the method further comprises verifying an integrity of the one or more parameters by comparing the integrity protection information with the expected integrity protection information.

BB24. The method of embodiment BB23, further comprising transmitting an indication of whether or not the integrity of the one or more parameters in the message is successfully verified.

BB25. The method of any of embodiments BB1-BB24, wherein the network equipment implements an authentication server.

BB26. The method of any of embodiments BB1-BB25, wherein the message is received from other network equipment that implements an AMF.

BB27. The method of any of embodiments BB1-BB26, wherein the message also includes one or more additional parameters with which the home network is to update the wireless communication device, and wherein the method further comprises generating integrity protection information that integrity protects the one or more additional parameters.

BB28. The method of embodiment BB27, further comprising transmitting the generated integrity protection information to other network equipment.

BB29. The method of any of embodiments BB27-BB28, wherein the one or more additional parameters include routing indicator data and/or default configured network slice selection assistance information.

BB. The method of any of the previous embodiments, further comprising:
obtaining user data; and
forwarding the user data to a host or a user equipment.

### Group C Embodiments

C1. A wireless communication device configured to perform any of the steps of any of the Group A embodiments.

C2. A wireless communication device comprising processing circuitry configured to perform any of the steps of any of the Group A embodiments.

C3. A wireless communication device comprising:
communication circuitry; and
processing circuitry configured to perform any of the steps of any of the Group A embodiments.

C4. A wireless communication device comprising:
processing circuitry configured to perform any of the steps of any of the Group A embodiments; and
power supply circuitry configured to supply power to the wireless communication device.

C5. A wireless communication device comprising:
processing circuitry and memory, the memory containing instructions executable by the processing circuitry whereby the wireless communication device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless communication device, causes the wireless communication device to carry out the steps of any of the Group A embodiments.

C8. A carrier containing the computer program of embodiment C7, wherein the carrier is one of an electronic signal, optical signal, radio signal, or computer readable storage medium.

C9. Network equipment configured to perform any of the steps of any of the Group B embodiments.

C10. Network equipment comprising processing circuitry configured to perform any of the steps of any of the Group B embodiments.

C11. Network equipment comprising:
communication circuitry; and
processing circuitry configured to perform any of the steps of any of the Group B embodiments.

C12. Network equipment comprising:
processing circuitry configured to perform any of the steps of any of the Group B embodiments;
power supply circuitry configured to supply power to the network equipment.

C13. Network equipment comprising:
processing circuitry and memory, the memory containing instructions executable by the processing circuitry whereby the network equipment is configured to perform any of the steps of any of the Group B embodiments.

C14. The network equipment of any of embodiments C9-C13, wherein the network equipment is a base station.

C15. A computer program comprising instructions which, when executed by at least one processor of network equipment, causes the network equipment to carry out the steps of any of the Group B embodiments.

C16. The computer program of embodiment C14, wherein the network equipment is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1.-34. (canceled)

35. A method performed by a wireless communication device, the method comprising:
generating key material during an authentication and key agreement procedure with a home network of the wireless communication device; and
transmitting, as part of a home network parameter update procedure to update the home network with one or more parameters, a message that includes the one or more parameters and that protects the one or more parameters using the generated key material.

36. The method of claim 35, wherein the home network parameter update procedure is triggered by the wireless communication device.

37. The method of claim 35, further comprising triggering the home network parameter update procedure responsive to:
detecting, by the wireless communication device, a change in at least one of the one or more parameters at the wireless communication device; or
detecting, by the wireless communication device, a change in an association between a permanent equipment identifier and a subscription permanent identifier associated with the wireless communication device.

38. The method of claim 35, wherein the home network parameter update procedure is independent from, and/or is performable separately from, a user equipment (UE) parameter update (UPU) procedure for updating the wireless communication device with a set of parameters stored at the home network.

39. The method of claim 35, wherein the one or more parameters include:
one or more privacy settings for location services; and/or
one or more parameters that govern which location services clients are or are not allowed to access location information for the wireless communication device; and/or
one or more capabilities of the wireless communication device; and/or
one or more parameters that indicate user consent for a service.

40. The method of claim 35, wherein the key material is generated during authentication and registration of the wireless communication device with the home network, and wherein the home network parameter update procedure is performed after registration of the wireless communication device with the home network.

41. The method of claim 35, wherein the message is a non-access stratum (NAS) message, wherein the message is transmitted to a network node implementing an access and mobility function (AMF), and wherein the key material used to protect the one or more parameters includes a key Kausf.

42. The method of claim 35, wherein the message further includes integrity protection information that integrity protects the one or more parameters, and wherein the method further comprises generating the integrity protection information from the one or more parameters and from the key material.

43. The method of claim 35, further comprising:
responsive to transmission of the message, receiving, as part of the home network parameter update procedure, a message acknowledging receipt by the home network of the one or more parameters, wherein the received message also includes one or more parameters to be updated at the wireless communication device, wherein the one or more parameters included in the received message are protected using the generated key material;
decrypting, and/or verifying an integrity of, and/or verifying a freshness of, the one or more parameters in the received message using the generated key material; and
updating the one or more parameters included in the received message at the wireless communication device responsive to successfully verifying the integrity of the one or more parameters included in the received message.

44. A method performed by network equipment, the method comprising:
receiving, as part of a home network parameter update procedure to update a home network of the wireless communication device with one or more parameters, a message that includes the one or more parameters and that protects the one or more parameters using key material generated during an authentication and key agreement procedure between the wireless communication device and the home network.

45. The method of claim 44, wherein the received message is the first message in the home network parameter update procedure.

46. The method of claim 44, wherein the home network parameter update procedure is independent from, and/or is performable separately from, a user equipment (UE) parameter update (UPU) procedure for updating the wireless communication device with a set of parameters stored at the home network.

47. The method of claim 44, wherein the one or more parameters include:
one or more privacy settings for location services; and/or
one or more parameters that govern which location services clients are or are not allowed to access location information for the wireless communication device; and/or
one or more capabilities of the wireless communication device; and/or
one or more parameters that indicate user consent for a service.

48. The method of claim 44, wherein the key material is generated during authentication and registration of the wireless communication device with the home network, and wherein the home network parameter update procedure is performed after registration of the wireless communication device with the home network.

49. The method of claim 44, wherein the message is a non-access stratum (NAS) message, and wherein the key material used to protect the one or more parameters includes a key Kausf.

50. The method of claim 44, wherein:
the network node implements an access and mobility function (AMF), wherein the method further comprises forwarding the message towards other network equipment, wherein the other network equipment implements a user data management (UDM) function; or
the network equipment implements a user data management (UDM) function.

51. The method of claim 50, further comprising decrypting, and/or verifying an integrity of, the one or more parameters in the message, wherein the message includes integrity protection information that integrity protects the one or more parameters, wherein verifying the integrity of the one or more parameters in the message comprises:
requesting an authentication server for expected integrity protection information and comparing the integrity protection information included in the message with the expected integrity protection information received from the authentication server; or
transmitting the received message to an authentication server and receiving, from the authentication server, an indication of whether or not the integrity of the one or more parameters in the message is successfully verified.

52. The method of claim 44, further comprising, responsive to receiving the message, transmitting, towards the wireless communication device as part of the home network parameter update procedure, a message acknowledging receipt by the home network of the one or more parameters, wherein the transmitted message also includes one or more parameters to be updated at the wireless communication device, wherein the one or more parameters included in the transmitted message are protected using the generated key material.

53. A wireless communication device comprising:
communication circuitry; and
processing circuitry configured to:
generate key material during an authentication and key agreement procedure with a home network of the wireless communication device; and
transmit, as part of a home network parameter update procedure to update the home network with one or more parameters, a message that includes the one or more parameters and that protects the one or more parameters using the generated key material.

54. Network equipment comprising:
communication circuitry; and
processing circuitry configured to receive, as part of a home network parameter update procedure to update a home network of the wireless communication device with one or more parameters, a message that includes the one or more parameters and that protects the one or more parameters using key material generated during an authentication and key agreement procedure between the wireless communication device and the home network.
